(19) United States
(12) Patent Application Publication
(10) Pub. No.: US 2020/0144615 A1
(43) Pub. Date: May 7, 2020

(54) ENERGY STORAGE DEVICE

(71) Applicant: GS Yuasa International Ltd., Kyoto (JP)

(72) Inventors: Tomonori KAKO, Kyoto (JP); Akihiko MIYAZAKI, Kyoto (JP); Kenta NAKAI, Kyoto (JP); Shota ITO, Kyoto (JP)

(21) Appl. No.: 16/181,690

(22) Filed: Nov. 6, 2018

(51) Int. Cl. H01M 4/505; H01M 4/587; H01M 4/525; H01M 10/0525; H01G 11/26; H01G 11/32; H01G 11/24; H01G 11/46

(52) U.S. Cl. CPC H01M 4/505; H01M 4/587; H01M 4/525; H01M 10/0525; H01M 2004/021; H01G 11/32; H01G 11/24; H01G 11/46; H01G 11/26

(57) ABSTRACT

There is provided an energy storage device which can have a relatively high initial power and whereby it becomes possible to prevent the occurrence of electrodeposition of lithium even when a charge-discharge procedure is performed repeatedly at a high rate. In the present embodiment, an energy storage device is provided, which includes a positive electrode and a negative electrode, wherein: the positive electrode has a positive active material layer containing a positive active material; the negative electrode has a negative active material layer containing a negative active material; the positive active material contains secondary particles that are aggregates of primary particles; when an average particle size of the primary particles that constitute the secondary particles in the positive active material is defined as FP (μm) and an average particle size D50 of the negative active material in the negative active material layer is defined as DN (μm), FP and DN satisfy a requirement represented by relational formula (1): 0.070≤FP/DN≤0.875; when the average particle size D50 of the positive active material is defined as DP (μm), DP and DN satisfy a requirement represented by relational formula (2): 0.7≤DP/DN≤5.0; and when a thickness of the positive active material layer is defined as TP (μm) and a thickness of the negative active material layer is defined as TN (μm), TP and TN satisfy a requirement represented by relational formula (3): 0.7≤TP/TN≤1.05.

### TECHNICAL FIELD

The present invention relates to an energy storage device such as a lithium ion secondary battery.

### BACKGROUND ART

Heretofore, a lithium ion battery equipped with a positive electrode, a negative electrode and a nonaqueous electrolyte solution is known. As the battery of this type, a battery is known, in which a negative electrode contains a negative active material containing at least one of graphite and amorphous carbon, a conductive auxiliary agent containing graphite, and a binder (see, for example, Patent Document 1).

In the battery disclosed in Patent Document 1, the negative active material has a spherical or block-like shape, the conductive auxiliary agent has a plate-like shape, and a part of an edge surface of the conductive auxiliary agent is in contact with the surface of the negative active material.

### PRIOR ART DOCUMENT

### Patent Document

Patent Document 1: WO 2013/008524

### SUMMARY OF THE INVENTION

### Problems to be Solved by the Invention

The present embodiment addresses the problem of providing an energy storage device which can have a relatively high initial power and whereby it becomes possible to prevent the occurrence of electrodeposition of lithium even when a charge-discharge procedure is performed repeatedly at a high rate.

### Means for Solving the Problems

The energy storage device according to the present embodiment includes a positive electrode and a negative electrode,

wherein:

the positive electrode has a positive active material layer containing

a positive active material;

the negative electrode has a negative active material layer containing a negative active material;

the positive active material contains secondary particles that are aggregates of primary particles;

when an average particle size of the primary particles that constitute the secondary particles in the positive active material is defined as FP (μm). and an average particle size D50 of the negative active material in the negative active material layer is defined as DN (μm), FP and DN satisfy a requirement represented by relational formula (1):

0.070≤FP/DN≤0.875;

when an average particle size D50 of the positive active material is defined as DP (μm), DP and DN satisfy a requirement represented by relational formula (2):

0.7≤DP/DN≤5,0; and

when a thickness of the positive active material layer is defined as TP (μm) and a thickness of the negative active material layer is defined as TN (μm), TP and TN satisfy a requirement represented by relational formula (3);

0.7≤TP/TN≤1.05.

### Advantages of the Invention

According to the present embodiment, a relatively high initial power can be achieved, and it becomes possible to prevent the occurrence of electrodeposition of lithium even when a charge-discharge procedure is performed repeatedly at a high rate.

### BRIEF DESCRIPTION OF THE DRAWINGS

FIG. 1 is a perspective view of an energy storage device according to the present embodiment.

FIG. 2 is a cross-sectional view taken along line II-II in FIG. 1.

### MODE FOR CARRYING OUT THE INVENTION

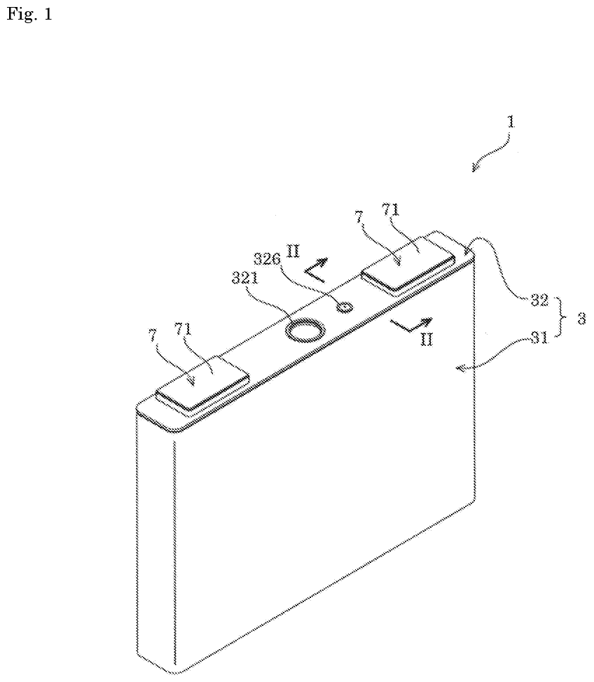

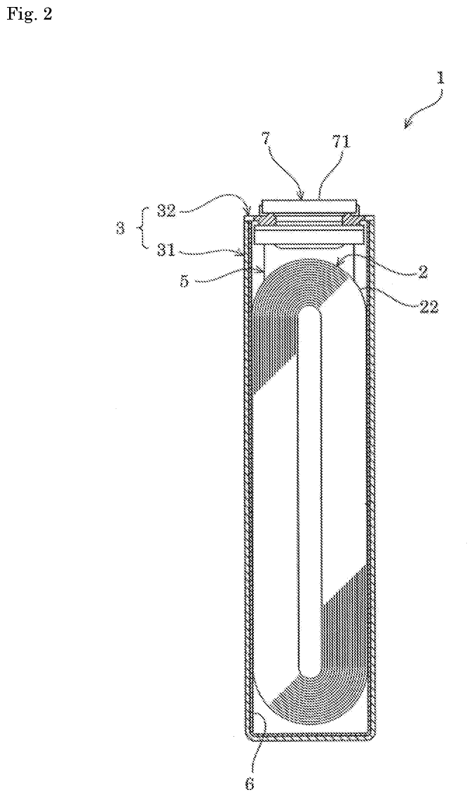

Hereinbelow, one embodiment of the energy storage device according to the present invention will be described with reference to FIGS. 1 and 2. The types of the energy storage device include a secondary battery, a capacitor and the like. In the present embodiment, a chargeable and dischargeable secondary battery is described as one example of the energy storage device. In the present embodiment, the names of assembly members (assembly elements) are used only for the description of the present embodiment, and are sometimes different from those used in the section “BACKGROUND ART”.

The energy storage device 1 according to the present embodiment is a nonaqueous electrolyte secondary battery. More specifically, the energy storage device 1 is a lithium ion secondary battery utilizing electron transfer that occurs in association with the transfer of lithium ions. The energy storage device 1 of this type can supply electronic energy. The energy storage device 1 may be used singly, or may be used in combination with another energy storage device or devices 1. More specifically, when both of the power to be required and the voltage to be required are small, the energy storage device 1 is used singly. On the other hand, when at least one of the power to be required and the voltage to be required is large, the energy storage device 1 is used in combination with another energy storage device or devices 1 and the combination of the energy storage devices 1 is used in an energy storage apparatus. In the electrical storage apparatus, the energy storage devices 1 used in the electrical storage apparatus can supply electronic energy

As shown in FIGS. 1 and 2, the energy storage device 1 is provided with: an electrode assembly 2 equipped with a positive electrode and a negative electrode; a case 3 in which the electrode assembly 2 is housed; and an external terminal 7 which is arranged outside of the case 3 and is electrically connected to the electrode assembly 2. In addition to the electrode assembly 2, the case 3 and the external terminal 7, the energy storage device 1 is also provided with a current collector member 5 which can electrically connect the electrode assembly 2 to the external terminal 7, and the like.

The electrode assembly 2 can be formed by winding a layered product 22 produced by laminating the positive electrode and the negative electrode which are insulated from each other by a separator.

The positive electrode is provided with a metal foil (positive electrode substrate) and an active material layer that is overlaid on a surface of the metal foil and contains an active material. In the present embodiment, the active material layers are overlaid respectively on both surfaces of the metal foil. The thickness of the positive electrode may be 20 to 150 μm an inclusive.

The metal foil has a belt-like form. In the present embodiment, the metal foil in the positive electrode is, for example, an aluminum foil. In the positive electrode, a part that is not coated with the positive active material layer (i.e., a part on which the positive active material layer is not formed) is formed at one edge part of the positive electrode as observed in the width direction (shorter-axis direction) of the belt-like form.

The positive active material layer contains a particulate active material (positive active material), a particulate conductive auxiliary agent and a binder. The positive active material contains secondary particles that are aggregates of primary particles. In other words, the positive active material layer contains secondary particles that are aggregates of primary particles of the positive active material. In the secondary particles, the primary particles may be fixed to each other. Each of the secondary particles may be hollow. In the case where each of the secondary particles is hollow, an electrolyte solution invades into the inside of each of the secondary particles, and therefore charge-discharge characteristics at a high rate can be further improved.

The average value (also referred to as “FP”, hereinafter) of the primary particles constituting the secondary particles may be 0.1 to 3.0 μm inclusive. The average value of the primary particles can be determined by measuring the diameters of at least one hundred primary particles in a scanning electron microscope image of the thicknesswise-cut cross section of the positive active material layer and then averaging the measurement values. In the case where each of the primary particles is not truly spherical, the longest diameter among the primary particles is employed as the diameter. The details about the measurement method are mentioned in the section “EXAMPLES”.

The thickness (also referred to as “TP”, hereinafter) of (a single layer of) the positive active material layer may be 5 to 100 μm inclusive. The thickness is an average of values obtained by measuring the thicknesses of at least five randomly selected points. More concretely, before the measurement of the thickness, the battery is discharged to, for example, 2.0 V at a current of 5 A and is then retained at 2.0 V for five hours. After the retention, the battery is rested for five hours, and the electrode assembly 2 is removed from the case while placing the battery in a dry room or a glovebox under an argon atmosphere. The positive electrode is removed from the electrode assembly 2, and is then washed with dimethyl carbonate (DMC) having a purity of 99.9 mass or more and a water content of 20 ppm or less at least three times, and then DMC is removed from the positive electrode by drying under vacuo. Subsequently, the thicknesses of randomly selected at least five points each containing the metal foil and the active material layers overlaid on both surfaces of the metal foil are measured. The thickness of the metal foil is subtracted from the average value, and then the value of the thickness obtained after the subtraction is divided by two to calculate the thickness TP of a single layer. The areal weight of (a single layer of) the positive active material layer may be 1 to 100 mg/cm² inclusive. The density of the positive active material layer may be 0.5 to 5.0 g/cm³ inclusive. The density is a density in a single layer that is so arranged as to cover one surface of the metal foil.

The positive active material is a compound capable of storing and releasing lithium ions. The average particle size D50 (also referred to as “DP”, hereinafter) of the positive active material may be 1 to 50 μm inclusive. The average particle size D50 of the active material is an average particle size (also referred to as a “median diameter”) at which the volume cumulative frequency becomes 50% in a volume cumulative distribution which is drawn from a smaller diameter side in a particle size distribution of the particle size. The average particle size D50 can be determined by a laser diffraction method using a laser diffraction-scattering-type particle size measurement device. The conditions for the measurement will be described in detail in the section “EXAMPLES”. In the measurement of the average particle size D50 of the active material of the produced battery, the battery is discharged and is then disassembled under a dry atmosphere, for example. Subsequently; the active material layer is removed, is then washed with dimethyl carbonate and is then crushed, and the crushed product is dried under vacuo for two hours or longer. Subsequently, the dried crushed product is subjected to a particle dispersion treatment with ultrasonic waves N′-methyl-2-pyrrolidone (NMP). A dispersion obtained after the dispersion treatment is measured using a particle size distribution measurement device to determine the average particle size D50. The active material and the conductive auxiliary agent can be separated from each other by utilizing the difference in specific gravity or the like.

An example of the positive active material is a lithium metal composite oxide represented by the compositional formula: LiₓMOₙ (wherein M represents at least one transition metal; 0.95≤x≤1.2; and n represents an integer of 2 to 4 inclusive). Specific examples of the lithium metal composite oxide include LiₓCoO₂, LiₓNiO₂, LiₓMn₂O₄, LiₓMnO₃, LiₓCo_{y}Ni_{1-y)}O₂, LiₓCo_{y}Ni_{z}Nm_{(1-y-z)}O₂ and LiₓNi_{z}Mn_{2-z)}O₄ (0<y<1, 0<z<1).

Another example of the positive active material is a polyanion compound represented by the formula: LiₐMe_{b}(AO_{c})_{d} (wherein Me represents at least one transition metal; A represents, for example, P, Si, B or V; 0.95≤a ≤1.2; b represents 1 or 2; c represents 4; and d represents an integer of 1 to 3 inclusive). Specific examples of the polyanion compound include LiFePO₄, LiMnPO₄, LiNiPO₄, LiCoPO₄, Li₃V₂(PO₄)₃, Li₂MnSiO₄ and Li₂CoPO₄F.

Some of the elements or polyanions in each of the compounds may be substituted by another element or another polyanion species. The surface of the particulate active material may be coated with a metal oxide such as ZrO₂, MgO or Al₂O₃ or carbon. As the positive active material, a conductive polymeric compound such as a disulfide, polypyrrole, polyparastyrene, polyacethylene and a polyacene-type material and a carbonaceous material having a pseudo-graphite structure can be used. The material for the positive active material is not limited to these compounds. The positive active material may be a single material selected from these compounds, or may be a mixture of two or more of these compounds.

In the present embodiment, the positive active material is a lithium metal composite oxide. The lithium metal composite oxide is preferably one represented by the compositional formula: LiₓCo_{y}Ni_{z}Mn_{(1-y-z)}O₂ (wherein 0.95≤x≤1.2, 0.1≤y≤0.34, 0<z, 1-y-z>0). When the positive active material is the lithium metal composite oxide represented by the above-mentioned compositional formula, the occurrence of lithium electrodeposition can be prevented more sufficiently even when a charge-discharge procedure is repeated at a high rate.

Specific examples of the lithium metal composite oxide represented by the chemical formula: LiₚNi_{q}MnᵣCoₛOₜ include LiNi_{1/3}Co_{1/3}Mn_{1/3}O₂, LiNi_{1/6}Co_{1/6}Mn_{2/3}O₂ and LiCoO₂.

Specific examples of the binder to be used in the positive active material layer include poly(vinylidene fluoride) (PVdF), a copolymer of ethylene and vinyl alcohol, poly(methyl methacrylate), poly(ethylene oxide), poly(propylene oxide), poly(vinyl alcohol), poly(acrylic acid), poly(methacrylic acid) and styrene butadiene rubber (SBR). The binder used in the present embodiment is poly(vinylidene fluoride).

The conductive auxiliary agent to be used in the positive active material layer is a carbonaceous material containing carbon in an amount of 98% by mass or more. Specific examples of the carbonaceous material include ketjen black (registered tradename), acethylene black and graphite. The positive active material layer in the present embodiment contains acethylene black as the conductive auxiliary agent.

The negative electrode includes a metal foil (negative electrode substrate) and a negative active material layer formed on the metal foil. In the present embodiment, the negative active material layers are overlaid respectively on both surfaces of the metal foil. The metal foil has a belt-like form. The metal foil to be used in the negative electrode of the present embodiment is, for example, a copper foil. In the negative electrode, a part that is not coated with the negative active material layer (i.e., a part on which the negative active material layer is not formed) is formed at one edge part of the negative electrode as observed in the width direction (shorter-axis direction) of the belt-like form. The thickness of the negative electrode may be 5 to 100 μm inclusive.

The negative active material layer contains a particulate active material (negative active material) and a binder. The negative active material layer is so arranged as to face the positive electrode with a separator interposed therebetween. The width of the negative active material layer is larger than that of the positive active material layer.

In the negative active material layer, the content ratio of the binder may be 5 to 10% by mass inclusive relative to the total mass of the negative active material and the binder.

The negative active material can contribute to electrode reactions including a charge reaction and a discharge reaction in the negative electrode. For example, the negative active material is a carbon material such as graphite and amorphous carbon (e.g., hardly graphitizable carbon, easily graphitizable carbon) or a material capable of causing an alloying reaction with a lithium ion (e.g., silicon (Si) and tin (Sn)). The negative active material in the present embodiment is preferably amorphous carbon, more preferably hardly graphitizable carbon. The term “amorphous carbon” as used herein refers to a carbon material of which the average interplanar distance d002 of (002) plane, which is measured by a wide-angle X-ray diffraction method using CuKα line as a radiation source after the battery is disassembled in a discharged state and the material is washed with water and is then dried, is 0.340 to 0.390 nm inclusive. The hardly graphitizable carbon has an average interplanar distance d002 of 0.360 to 0.390 nm inclusive. When the negative active material is amorphous carbon, the number of sites to which Li ions can be inserted further varies depending on the particle size of the active material. In other words, when the particle size of the active material becomes smaller and the surface area per unit volume becomes more larger, the number of sites to which Li ions can be inserted further increases. As a result, the occurrence of lithium electrodeposition can be prevented more effectively.

The average particle size D50 (also referred to as “DN”, hereinafter) of the negative active material may be 1 to 10 μm inclusive. The average particle size D50 is preferably 1.0 to 5.9 μm inclusive. When the DN (i.e., the average particle size D50 of the negative active material) is 1.0 to 5.9 μm inclusive, a relatively high initial power can be achieved more reliably and therefore the occurrence of lithium electrodeposition can be prevented even when a charge-discharge procedure is repeated at a high rate. The average particle size D50 of the negative active material can be measured in the same manner as in the determination of the average particle size D50 of the positive active material as mentioned above.

The thickness of (a single layer of) the negative active material layer (wherein the thickness is also referred to as “TN”, hereinafter) may be 5 to 100 μm inclusive. The thickness can be measured in the same manner as in the determination of the thickness of the positive active material layer as mentioned above. The areal weight (per a single layer) of the negative active material layer may be 1 to 100 mg/cm² inclusive. The density (per a single layer) of the negative active material layer may be 0.5 to 5.0 g/cm³ inclusive.

The binder to be used in the negative active material layer is the same as that used in the positive active material layer. The binder used in the present embodiment is poly(vinylidene fluoride).

The negative active material layer may additionally contain a conductive auxiliary agent such as ketjen black (registered tradename), acethylene black and graphite.

When the average particle size of the primary particles that constitute the secondary particles in the positive active material is defined as FP (μm) and the average particle size D50 of the negative active material in the negative active material layer is defined as DN (μm), FP and DN satisfy the requirement represented by relational formula (1):

0.070≤FP/DN≤0.875.

When the requirement represented by the formula: 0.070≤FP/DN in relational formula (1) is satisfied, Li ions transferred from the positive active material can be inserted into the negative active material easily even during charging at a high rate. Therefore, the Li ions are reduced on the surface of the negative active material and the Li electrodeposition can rarely occurs. In this manner, the occurrence of lithium electrodeposition can be prevented even when a charge-discharge procedure is repeated at a high rate. When the requirement represented by the formula: FP/DN≤0.875 is satisfied, a relatively high initial power can be achieved.

When the average particle size D50 of the positive active material is defined as DP (μm), DP and DN satisfy the requirement represented by relational formula (2): 0.7≤DP/DN≤5.0, In the relational formula (2), DP and DN may satisfy the formula: 0.7<DP/DN or 0.75≤DP/DN. When 0.7≤DP/DN in the relational formula (2) is satisfied, the current density per the negative active material can become larger than that per the positive active material during charging. As a result, it becomes possible to prevent the reduction of Li ions on the surface of the negative active material and the Li electrodeposition becomes less likely to occurs. Accordingly, the occurrence of lithium electrodeposition can be prevented more sufficiently even when a charge-discharge procedure is repeated at a high rate. On the other hand, when DP/DN≤5.0, the variation in depth of charge in the negative active material layer can be reduced even when charging is carried out at a high rate. It also becomes possible to prevent the occurrence of Li electrodeposition at a part at which the depth of charge is increased when cycle charge-discharge is carried out under high load. When DP/DN≤5.0, it becomes possible to achieve a relatively high initial power.

When the thickness of the positive active material layer is defined as TP (μm) and the thickness of the negative active material layer is defined as TN (μm), TP and TN satisfy the requirement represented by relational formula (3): 0.7≤TP/TN≤1.05. In relational formula (3), the requirement represented by the formula: 0.9≤TP/TN≤1.0 may be satisfied. As shown in relational formula (3), when the proportion of the thickness of the positive active material layer is close to the thickness of the negative active material layer, the ununiform occurrence of the reaction in the active material layer thickness direction can be prevented during a charge-discharge procedure, When the depth of charge increases during charging, Li electrodeposition tends to occur. However, when the requirement represented by relational formula (3) is satisfied, it becomes possible to prevent the increase in the depth of charge on the separator side rather than the metal foil side of the negative active material layer. As a result, the occurrence of lithium electrodeposition can be prevented even when a charge-discharge procedure is repeated at a high rate.

As mentioned above, when all of the requirements represented by relational formulae (1) to (3) are satisfied, in the energy storage device 1 according to the present embodiment, a relatively high initial power can be achieved and the occurrence of lithium electrodeposition can be prevented even when a charge-discharge procedure is repeated at a high rate.

In the electrode assembly 2 in the present embodiment, the positive electrode and the negative electrode which are configured as mentioned above are wound while being insulated from each other by a separator. Namely, in the electrode assembly 2 in the present embodiment, a layered product 22 composed of the positive electrode, the negative electrode and the separator is wound. The separator is a member having insulation properties. The separator is arranged between the positive electrode and the negative electrode. Accordingly, in an electrode assembly 2 (more specifically, a layered product 22), the positive electrode and the negative electrode are insulated from each other. In a case 3, the separator can carry the electrolyte solution. Accordingly, lithium ions can transfer between the positive electrode and the negative electrode, which are laminated on each other with the separator interposed therebetween, during the charging and discharging of the energy storage device 1.

In the electrode assembly 2, the positive active material layer and the negative active material layer face each other, and the 1CA current density which is a value determined by dividing a rated capacity (which will be described in detail below) by the area of a part at which the positive active material layer and the negative active material layer are overlaid on each other as observed in the thickness direction, may be 0.8 mA/cm² or more. The 1CA current density may be 1.4 mA/cm² or less. If the 1CA current density is less than 0.8 mA/cm², Li electrodeposition may become less likely to occur. If the 1CA current density is 0.8 mA/cm² or more, Li electrodeposition may become likely to occur slightly. In the energy storage device 1 according to the present embodiment, even if the 1CA current density is 0.8 mA/cm² or more, all of the requirements represented by the above-mentioned relational formulae (1) to (3) are satisfied, and therefore the occurrence of lithium electrodeposition can be prevented satisfactorily.

The separator has a belt-like form. The separator is provided with a porous separator substrate. The separator in the present embodiment is provided with only a separator substrate. The separator is arranged between the positive electrode and the negative electrode for the purpose of preventing the short circuit between the positive electrode and the negative electrode.

The separator substrate is porous. The separator substrate is, for example, a woven cloth, a non-woven cloth or a porous film. Examples of the material for the separator substrate include a polymeric compound, a glass and a ceramic. Specific examples of the polymeric compound include: a polyester such as polyacrylonitrile (PAN), polyimide (PA) and poly(ethylene terephthalate) (PET); a polyolefin (PO) such as polypropylene (PP) and polyethylene (PE); and cellulose.

The width (i.e., the size of the belt-like form as observed in the shorter-axis direction) of the separator is slightly larger than that of the negative active material layer. The separator is arranged between the positive electrode and the negative electrode which are overlaid on each other in such a manner that the positive electrode and the negative electrode are misaligned with each other in the width direction so that the positive active material layer can be overlaid on the negative active material layer.

The electrolyte solution is a nonaqueous solution-based electrolyte solution. The electrolyte solution can be prepared by dissolving an electrolyte salt in an organic solvent. Specific examples of the organic solvent include: a cyclic carbonic acid ester such as propylene carbonate and ethylene carbonate; and a linear carbonate such as dimethyl carbonate, diethyl carbonate and ethyl methyl carbonate. Specific examples of the electrolyte salt LiClO₄, LiBR₄ and LiPF₆. The electrolyte solution in the present embodiment is one prepared by dissolving 0.5 to 1.5 mol/L, of LiPF₆ in a mixed solvent prepared by mixing propylene carbonate, dimethyl carbonate and ethyl methyl carbonate at a specified mixing ratio.

The case 3 is provided with a case main body 31 having an opening and a lid plate 32 that can close the opening in the case main body 31. In the case 3, the electrolyte solution is enclosed in an inner space of the case 3 together with the electrode assembly 2, the current collector member 5 and the like. The case 3 is made from a metal having resistance to electrolyte solutions.

The case 3 is formed by bonding the periphery of the opening of the case main body 31 to the periphery of the rectangular lid plate 32 while overlaying both of the peripheries on each other. The case 3 has an inner space defined by the case main body 31 and the lid plate 32. In the present embodiment, the periphery of the opening of the case main body 31 and the periphery of the rectangular lid plate 32 are bonded to each other by welding.

The lid plate 32 is provided with a gas release valve 321 through which a gas in the case 3 can be released to the outside. The gas release valve 321 is so configured that the gas can be released from the case 3 to the outside when the internal pressure in the case 3 increases to a predetermined pressure. The gas release valve 321 is arranged at a center part of the lid plate 32.

In the case 3, there is provided an electrolyte solution filling hole through which the electrolyte solution can be injected. The electrolyte solution filling hole allows the communication between the inside and the outside of the case 3. The electrolyte solution filling hole is formed in the lid plate 32. The electrolyte solution filling hole can be hermetically sealed (closed) with the electrolyte solution filling plug 326. The electrolyte solution filling plug 326 is fixed to the case 3 (or the lid plate 32 in the present embodiment) by welding.

The external terminal 7 is a part which is electrically connected to an external terminal 7 of another lithium ion secondary battery 1, an external apparatus or the like. The external terminal 7 is formed by a member having electrical conductivity. The external terminal 7 has a surface 71 to which a bus bar or the like can be welded. The surface 71 is flat.

The current collector member 5 is arranged in the case 3 and is directly or indirectly connected to the electrode assembly 2 in an electrically conducive manner. The current collector member 5 in the present embodiment is formed by a member having electrical conductivity. The current collector member 5 is arranged along the inner surface of the case 3. The current collector member 5 is electrically connected to the positive electrode and the negative electrode in the lithium ion secondary battery 1.

In the lithium ion secondary battery 1 according to the present embodiment, an electrode assembly 2 (more concretely, an electrode assembly 2 and a current collector member 5) which is enclosed in a bag-shaped insulating cover 6 capable of insulating the electrode assembly 2 and a case 3 from each other is housed in the case 3.

The energy storage device 1 according to the present embodiment may have a rated capacity of 4 to 10 Ah inclusive. For example, the rated capacity can be increased by increasing the amount of the active material, and can be decreased by decreasing the amount of the active material.

Next, the method for producing the energy storage device 1 according to the above-mentioned embodiment will be described.

In the method for producing the energy storage device 1, each of electrodes (a positive electrode and a negative electrode) is produced by applying a composite containing an active material onto a metal foil (electrode substrate) to form an active material layer on the metal foil. Subsequently, the positive electrode, a separator and the negative electrode are laminated together to form an electrode assembly 2. Subsequently, the electrode assembly 2 is housed in a case 3 and then an electrolyte solution is injected into the case 3 to assemble the energy storage device 1.

In the production of the electrode (positive electrode), a composite containing the active material, the binder and the solvent is applied on both surfaces of the metal foil to form positive active material layers. The areal weight of the positive active material layer can be controlled by controlling the amount of the composite to be applied. As the application method for forming the positive active material layer, a commonly employed method may be employed. The applied positive active material layer is roll-pressed under a predetermined pressure. The thickness or density of the positive active material layer can be controlled by controlling the pressing pressure. The negative electrode can also be produced in the same manner.

In the formation of the electrode assembly 2, a layered product 22 in which the separator is sandwiched between the positive electrode and the negative electrode is wound to form the electrode assembly 2. More specifically, the positive electrode, the separator and the negative electrode are laminated together in such a manner that the positive active material layer can face the negative active material layer with the separator interposed therebetween to form the layered product 22. Subsequently, the layered product 22 is wound to form the electrode assembly 2.

In the assembling of the energy storage device 1, the electrode assembly 2 is housed in the case main body 31 of the case 3, the opening of the case main body 31 is closed with the lid plate 32, and then an electrolyte solution is injected into the case 3. In the closing of the opening of the case main body 31 with the lid plate 32, the electrode assembly 2 is housed in the inside of the case main body 31, and then the opening of the case main body 31 is closed with the lid plate 32 while electrically connecting the positive electrode to one of the external terminals 7 and electrically connecting the negative electrode to the other of the external terminals 7. In the injection of the electrolyte solution into the case 3, the electrolyte solution is injected into the case 3 through an injection hole formed in the lid plate 32 in the case 3.

The energy storage device of the present invention is not limited to the above-mentioned embodiment and, as a matter of course, various modification may be made within the scope without departing from the concept of the invention. For example, the configuration of one embodiment can be added to the configuration of another embodiment, and a part of the configuration of one embodiment can be substituted by a part of the configuration of another embodiment. Alternatively, a part of the configuration of an embodiment can be eliminated.

In the above-mentioned embodiment, a positive electrode in which an active material layer containing an active material is in directly contact with a metal foil is described in detail. In the present invention, however, the positive electrode may have a conductive layer containing a binder and a conductive auxiliary agent but containing no active material.

In the above-mentioned embodiment, an electrode in which active material layers are arranged respectively on both surfaces of a metal foil in each of electrodes is described. In the energy storage device according to the present invention, however, the positive electrode or the negative electrode may have an active material layer only on one surface of the metal foil.

In the above-mentioned embodiment, an energy storage device 1 provided with an electrode assembly 2 in which a layered product 22 is wound is described in detail. However, the energy storage device of the present invention may also be provided with an unwound layered product 22. More specifically, the energy storage device may be provided with an electrode assembly in which a positive electrode, a separator, a negative electrode and a separator each formed in a rectangular shape are laminated in this order multiple times.

In the above-mentioned embodiment, a case where the energy storage device 1 is used as a chargeable-dischargeable nonaqueous electrolyte secondary battery (e.g., a lithium ion secondary battery) is described. However, the type or size (capacity) of the energy storage device 1 may be any one. In the above-mentioned embodiment, a lithium ion secondary battery is described as one example of the energy storage device 1. However, the energy storage device 1 is not limited to the lithium ion secondary battery. For example, present invention can be applied to various secondary batteries and can also applied to energy storage devices for capacitors such as electric double layer capacitors.

The energy storage device 1 (e.g., a battery) may be used in an electrical storage apparatus (e.g., a battery module in the case where the energy storage device is a battery). The electrical storage apparatus is provided with at least two energy storage devices 1 and a bus bar member for electrically connecting the two (different) energy storage devices 1 to each other. In this case, the technique of the present invention may be applied to at least one of the energy storage devices.

### EXAMPLES

A nonaqueous electrolyte secondary battery (lithium ion secondary battery) was produced in the following manner.

### Test Example 1

### (1) Production of Positive Electrode

As a positive active material, LiNi_{1/3}Co_{1/3}Mn_{1/3}O₂ having an average particle size D50 (DP as mentioned above) of 5.0 μm was used. As a conductive auxiliary agent, acethylene black was used. As a binder, PVdF was used. A positive electrode paste to be used for the production of a positive active material layer was prepared by using N-methyl-2-pyrrolidone (NMP) as a solvent and by mixing and kneading the solvent, the conductive auxiliary agent and the binder together so that the contents of the conductive auxiliary agent, the binder and the positive active material became 4.5% by mass, 4.5% by mass and 91% by mass, respectively. The prepared positive electrode paste was applied onto an aluminum foil having a thickness of 15 μm. The positive electrode paste was applied in such a manner that the width of the active material layer became 83 mm, the width of an uncoated part (i.e., an active material layer-unformed area) became 11 mm and the areal weight became 6.9 mg/cm² after the application. After drying the positive electrode paste, the dried product was roll-pressed so that the active material filling density in the active material layer became 2.48 g/cm³, and then water was removed from the roll-pressed product by drying under vacuo to produce a positive electrode. The thickness (TP) per a single layer of the positive active material layer was 32 μm.

### Active Material

Secondary particles that were aggregates of primary particles were used. The average particle size (FP as mentioned above) of the primary particles constituting the secondary particles was 0.18 μm. The average particle size was determined by measuring the diameters of at least one hundred primary particles in an image of a positive active material layer as observed on a scanning electron microscope and then averaging the measurement values. In the case where each of the primary particles was not truly spherical, the longest diameter among the primary particles was employed as the diameter.

### (2) Production of Negative Electrode

As a negative active material, hardly graphitizable carbon having an average particle size D50 (DN as mentioned above) of 2.5 μm was used. As a binder, PVdF was used. A negative electrode paste was prepared by using NMP as a solvent and by mixing and kneading the solvent, the binder and the active material together so that the contents of the binder and the negative active material became 7% by mass and 93% by mass, respectively, The prepared negative electrode paste was applied onto a copper foil having a thickness of 8 μm. The negative electrode paste was applied in such a manner that the width of the active material layer become 87 mm, the width of an unapplied part (an active material layer-unformed region) became 9 mm and the areal weight become 3.3 mg/cm² after the application. After drying the resultant product, the dried product was roll-pressed so that the active material filling density in the active material layer became 1.01 g/cm³, and. then water was removed from the roll-pressed product by drying under vacuo to produce a negative electrode. The thickness (TN) per a single layer of the negative active material layer was 35 μm.

### (3) Separator

As a separator, a polyethylene-made microporous film having a thickness of 21 μm was used. The polyethylene-made microporous film had a gas permeability of 100 sec/100 cc.

### (4) Preparation of Electrolyte Solution

As an electrolyte solution, one prepared in the following manner was used. A solvent prepared by mixing a part by volume of propylene carbonate, a part by volume of dimethyl carbonate and a part by volume of ethyl methyl carbonate together was used as a nonaqueous solvent, and then LiPF₆ was dissolved in the nonaqueous solvent so that the salt concentration became 1.2 mol/L to prepare the electrolyte solution.

### (5) Arrangement of Electrode Assembly in Case

A battery was assembled by a commonly employed method using the positive electrode, the negative electrode, the electrolyte solution, the separator and a case.

Firstly, a sheet-like article in which the positive electrode and the negative electrode were laminated on each other with the separator interposed therebetween was wound. An area at which the positive active material layer and the negative active material layer were overlaid on each other was 5775 cm². Subsequently; the wound electrode assembly was placed in a case main body of an aluminum-made prismatic container can which served as the case. Subsequently, the positive electrode and the negative electrode were electrically connected to two external terminals. A lid plate was attached to the case main body. The electrolyte solution was injected into the case through an electrolyte solution filling port formed in the lid plate in the case. Finally, the electrolyte solution filling port in the case was sealed to hermetically seal the case.

### (6) Confirmation of Capacity of Produced Battery

Firstly, an initial discharge capacity of the battery was measured in the following manner. More concretely, the battery was charged to 4.2 V at a constant current of 5 A at 25° C., was then further charged at a constant voltage of 4.2 V for three hours in total, and was then discharged at a constant current of 5 A under the condition of an end-of-discharge voltage of 2.4 V to measure the initial discharge capacity. From the result, it was found that a 1CA current density, which was a value determined by dividing a rated capacity by an area of a part at which the positive active material layer and the negative active material layer were overlaid on each other as observed in the thickness direction, was 0.88 mA/cm².

### Average Particle Size D50 of Each of Positive Active Material and Negative Active Material

A plate of each of a positive electrode and a negative electrode was removed from the produced battery. The plate was subjected to a dispersion treatment for dispersing particles with ultrasonic waves while placing the plate in N-methyl-2-pyrrolidone (NMP) or water. After the dispersion treatment, the resultant solution was filtrated to produce an active material. A laser diffraction-mode particle size distribution measurement device (“SALD2200” manufactured by Shimadzu Corporation) was used as a measurement device, and a specialized application software DMS ver.2 was used as a measurement control software. As a concrete measurement procedure, a scattering measurement mode was employed, then a wet-mode cell in which a dispersion having a measurement sample (active material) dispersed therein was circulating was placed under an ultrasonic environment for two minutes, and then the cell was irradiated with a laser beam to obtain a scattered light distribution from the measurement sample. The scattered light distribution was approximated by a long-normal distribution. The particle size corresponding to a cumulation degree of 50% (D50) in a range in which the smallest value was set to 0.021 μm and the largest value was set to 2000 μm in the particle size distribution (transverse axis, σ) was defined as an average particle size. The dispersion contained a surfactant and also contained SN dispersant 7347-C (product name) or Triton X-100 (product name) as a dispersant.

Some droplets of the dispersant were added to the dispersion.

### Test Examples 2 to 25

Lithium ion secondary batteries were produced in the same manner as in Test Example 1, except that modifications were added so that the FP/DN values, the DP/DN values and the TN/TN values for the batteries were changed to those values shown in Table 1. Furthermore, the values of DP, FP, TP, TN and DN were also changed appropriately.

TABLE 1

| | | | | | | | | | 1CA | Presence of | | |
|---|---|---|---|---|---|---|---|---|---|---|---|---|
| | | | | | | | | | current | Li | Initial | Power1 |
| | | | | | | | | | density | electrode- | power | ratio |
| | DP/DN | FP/DN | TP/TN | DP [μm] | FP [μm] | TP [mm] | TN [mm] | DN [μm] | [mA/cm²] | position | [W] | [%] |
| Test Example 1 | 2.00 | 0.07 | 0.91 | 5.0 | 0.18 | 0.032 | 0.035 | 2.5 | 0.88 | Absent | 394 | 100 |
| Test Example 2 | 0.70 | 0.07 | 0.91 | 1.8 | 0.18 | 0.032 | 0.035 | 2.5 | 0.88 | Absent | 453 | 115 |
| Test Example 3 | 5.00 | 0.53 | 0.91 | 12.5 | 1.31 | 0.032 | 0.035 | 2.5 | 0.88 | Absent | 323 | 82 |
| Test Example 4 | 0.60 | 0.07 | 0.91 | 1.5 | 0.17 | 0.032 | 0.035 | 2.5 | 0.88 | Present | 469 | 119 |
| Test Example 5 | 6.00 | 0.07 | 0.91 | 15 | 0.17 | 0.032 | 0.035 | 2.5 | 0.88 | Absent | 307 | 78 |
| Test Example 6 | 0.70 | 0.07 | 0.91 | 2.3 | 0.24 | 0.032 | 0.035 | 3.3 | 0.88 | Absent | 351 | 100 |
| Test Example 7 | 2.00 | 0.21 | 0.91 | 6.6 | 0.69 | 0.032 | 0.035 | 3.3 | 0.88 | Absent | 323 | 92 |
| Test Example 8 | 5.00 | 0.53 | 0.91 | 16.5 | 1.73 | 0.032 | 0.035 | 3.3 | 0.88 | Absent | 291 | 83 |
| Test Example 9 | 5.00 | 0.07 | 0.91 | 16.5 | 0.24 | 0.032 | 0.035 | 3.3 | 0.88 | Absent | 312 | 89 |
| Test Example 10 | 5.00 | 0.06 | 0.91 | 16.5 | 0.20 | 0.035 | 0.035 | 3.3 | 0.88 | Present | 316 | 90 |
| Test Example 11 | 5.00 | 0.85 | 0.91 | 16.5 | 2.80 | 0.032 | 0.035 | 3.3 | 0.88 | Absent | 284 | 81 |
| Test Example 12 | 5.00 | 0.876 | 0.91 | 16.5 | 2.89 | 0.032 | 0.035 | 3.3 | 0.88 | Absent | 263 | 75 |
| Test Example 13 | 0.60 | 0.08 | 0.91 | 2.0 | 0.25 | 0.032 | 0.035 | 3.3 | 0.88 | Present | 372 | 106 |
| Test Example 14 | 6.00 | 0.08 | 0.91 | 19.8 | 0.25 | 0.032 | 0.035 | 3.3 | 0.88 | Absent | 274 | 78 |
| Test Example 15 | 0.70 | 0.07 | 0.91 | 4.1 | 0.44 | 0,032 | 0.035 | 5.9 | 0.88 | Absent | 339 | 100 |
| Test Example 16 | 2.00 | 0.21 | 0.91 | 11.8 | 1.24 | 0.032 | 0.035 | 5.9 | 0.88 | Absent | 200 | 73 |
| Test Example 17 | 2.00 | 0.07 | 0.91 | 11.8 | 0.39 | 0.032 | 0.035 | 5.9 | 0.88 | Absent | 211 | 77 |
| Test Example 18 | 2.00 | 0.06 | 0.91 | 11.8 | 0.35 | 0.032 | 0.035 | 5.9 | 0.88 | Present | 214 | 78 |
| Test Example 19 | 0.59 | 0.07 | 0.91 | 3.5 | 0.43 | 0.032 | 0.035 | 5.9 | 0.88 | Present | 235 | 86 |
| Test Example 20 | 2.00 | 0.21 | 0.91 | 5.0 | 0.53 | 0.032 | 0.035 | 2.5 | 0.88 | Absent | | |
| Test Example 21 | 2.00 | 0.21 | 1.00 | 5.0 | 0.53 | 0.038 | 0.038 | 2.5 | 0.97 | Absent | | |
| Test Example 22 | 2.00 | 0.21 | 1.04 | 5.0 | 0.53 | 0.038 | 0.036 | 2.5 | 0.97 | Absent | | |
| Test Example 23 | 2.00 | 0.21 | 1.07 | 5.0 | 0.53 | 0.038 | 0.035 | 2.5 | 0.97 | Present | | |
| Test Example 24 | 2.00 | 0.21 | 0.77 | 5.0 | 0.53 | 0.037 | 0.048 | 2.5 | 0.95 | Absent | | |
| Test Example 25 | 2.00 | 0.21 | 0.69 | 5.0 | 0.53 | 0.037 | 0.053 | 2.5 | 0.95 | Present | | |

### Power Confirmation Test

A battery that had been subjected to a capacity confirmation test was charged with 20% of a discharge capacity obtained in the capacity confirmation test to adjust the SOC (State Of Charge) of the battery to 20%. Subsequently, the battery was further retained at −10° C. for four hours and was then discharged at a constant voltage of 2.3 V for 1 second to calculate a low-temperature power (initial power) from a current value at 1 second. The results of some of the above-mentioned Test Examples are shown in Table 1. With respect to Test Examples 2 to 5, relative values (ratios) of initial powers relative to the result of Test Example 1 are shown. With respect to Test Examples 7 to 14, relative values (ratios) of initial powers relative to the result of Test Example 6 are shown. With respect to Test Examples 15 to 19, relative values (ratios) of initial powers relative to the result of Test Example 15 are shown. An initial power tends to vary depending on the average particle size D50 (DN as mentioned above) of the negative active material. Therefore, with respect to test examples in which the DN values were the same as each other, the initial power was also expressed in a relative value (ratio) as well as a calculated value.

### Evaluation of Electrodeposition

In order to decide test conditions for a charge-discharge cycle test, a battery that had been conditioned so as to have a SOC of 50% was retained at 55° C. for four hours, and was then charged at a constant current of 40 A until the SOC became 80%. Subsequently, the battery was discharged from a SOC of 80% to a SOC of 20% at a constant current of 40 A to determine a charge voltage V80 at a SOC of 80% and a discharge voltage V20 at a SOC of 20%.

A 55° C. cycle test was carried out at a constant current of 40 A, and was carried out continuously at a cut-off voltage of V80 during charging and a cut-off voltage of V20 during discharging without setting a resting time. The cycle time was set to 3000 hours in total. After the completion of the cycle test for 3000 hours, the battery was retained at 25° C. for four hours, and then the above-mentioned capacity confirmation test and a low-temperature power confirmation test were carried out. Subsequently, the battery was discharged to 2.0 V at a current of 5 A, and was then retained at 2.0 V for five hours. After the retention, the battery was rested for five hours, and then an electrode assembly was removed from a case while placing the battery in a dry room or a glovebox under an argon atmosphere. The surface of a plate of the negative electrode was observed with naked eyes to confirm the presence or absence of the occurrence of Li electrodeposition.

In the batteries of examples, relatively high initial powers were achieved, and the occurrence of lithium electrodeposition was prevented satisfactorily. On the other hand, in the battery of comparative examples, it was not always possible to achieve both of the production of relatively high initial powers and the prevention of the occurrence of lithium electrodeposition. In addition, when the FP/DN value was larger than 0.875 or the DP/DN value was larger than 5, the initial power tended to become small.

### DESCRIPTION OF REFERENCE SIGNS

1: energy storage device (nonaqueous electrolyte secondary battery

2: electrode assembly

3: case

31: case main body

32: lid plate

5: current collector member

6: insulating cover

7: external terminal

71: surface

1. An energy storage device comprising a positive electrode and a negative electrode,
wherein:
the positive electrode has a positive active material layer containing a positive active material;
the negative electrode has a negative active material layer containing a negative active material;
the positive active material contains secondary particles that are aggregates of primary particles;
when an average particle size of the primary particles that constitute the secondary particles in the positive active material is defined as FP (μm) and an average particle size D50 of the negative active material in the negative active material layer is defined as DN (μm), FP and DN satisfy a requirement represented by relational formula (1):
0.070≤FP/DN≤0.875;
when an average particle size D50 of the positive active material is defined as DP (μm), DP and DN satisfy a requirement represented by relational formula (2):
0.7≤DP/DN≤5.0; and
when a thickness of the positive active material layer is defined as TP (μm) and a thickness of the negative active material layer is defined as TN (μm), TP and TN satisfy a requirement represented by relational formula (3):
0.7≤TP/TN≤1.05.

2. The energy storage device according to claim 1, wherein DN is 1.0 to 5.9 μm inclusive.

3. The energy storage device according to claim 1, wherein the negative active material is amorphous carbon.

4. The energy storage device according to claim 1, wherein the positive active material is a lithium metal composite oxide represented by a compositional formula: LiₓCo_{y}Ni_{z}Mn_{(1-y-z)}O₂ (provided that 0.95≤x≤1.2, 0.1≤y≤0.34, 0<z and 1-y-z>0).
